(19) United States
(12) Patent Application Publication
(10) Pub. No.: US 2022/0083712 A1
(43) Pub. Date: Mar. 17, 2022

(54) OBJECT MANUFACTURING SIMULATION

(71) Applicant: Hewlett-Packard Development Company, L.P., Spring, TX (US)

(72) Inventors: Jun Zeng, Palo Alto, CA (US); Carlos Alberto Lopez Collier de la Martiere, Guadalajara (MX); Maria Fabiola Leyva Mendivil, Guadalajara (MX); Jose Israel Figueroa Angulo, Guadalajara (MX)

(73) Assignee: Hewlett-Packard Development Company, L.P., Spring, TX (US)

(21) Appl. No.: 17/414,820

(22) PCT Filed: Jun. 7, 2019
(86) PCT No.: PCT/US2019/036152

§ 371 Date: Jun. 16, 2021

(51) Int. Cl. G06F 30/23; B29C 64/393; G06T 17/10

(52) U.S. Cl. CPC G06F 30/23; B33Y 50/02; G06T 17/10; B29C 64/393

(57) ABSTRACT

Examples of methods for simulating three-dimensional (3D) manufacturing of an object are described herein. In some examples, a method includes simulating 3D manufacturing of an object based on a value. In some examples, the value indicates a sub-voxel proportion of a voxel that is occupied by the object. Some examples of the methods may include determining the value for the voxel.

### BACKGROUND

Three-dimensional (3D) solid parts may be produced from a digital model using additive manufacturing. Additive manufacturing may be used in rapid prototyping, mold generation, mold master generation, and short-run manufacturing. Additive manufacturing involves the application of successive layers of build material. This is unlike traditional machining processes that often remove material to create the final part. In some additive manufacturing techniques, the build material may be cured or fused.

### BRIEF DESCRIPTION OF THE DRAWINGS

FIG. 1 is a flow diagram illustrating an example of a method for object manufacturing simulation;

FIG. 2 is a flow diagram illustrating another example of a method for object manufacturing simulation;

FIG. 3 is a block diagram of an example of an apparatus that may be used in object manufacturing simulation;

FIG. 4 is a block diagram illustrating an example of a computer-readable medium for object manufacturing simulation;

FIG. 5 is a diagram illustrating an example of a voxel that is partially occupied by an object; and

FIG. 6 is a simplified perspective view of an example of visualizations of simulation results in accordance with some examples of the techniques described herein.

### DETAILED DESCRIPTION

Additive manufacturing may be used to manufacture 3D objects. Three-dimensional (3D) printing is an example of additive manufacturing. For example, thermal energy may be projected over material in a build area, where a phase change and solidification in the material may occur at certain voxels. A voxel is a representation of a location in a 3D space. For example, a voxel may represent a component of a 3D space. For instance, a voxel may represent a volume that is a subset of the 3D space. In some examples, voxels may be arranged on a 3D grid. For instance, a voxel may be cuboid or rectangular prismatic in shape. In some examples, voxels in the 3D space may be uniformly sized or non-uniformly sized. Examples of a voxel size dimension may include 25.4 millimeters (mm)/150≈170 microns for 150 dots per inch (dpi), 490 microns for 50 dpi, 2 mm, 4 mm, etc. The term “voxel level” and variations thereof may refer to a resolution, scale, or density corresponding to voxel size. In some examples, the term “voxel” and variations thereof may refer to a “thermal voxel.” In some examples, the size of a thermal voxel may be defined as a minimum that is thermally meaningful (e.g., greater than or equal to 42 microns or 600 dots per inch (dpi)). A set of voxels may be utilized to represent a build volume. A build volume is a volume in which an object or objects may be manufactured. In some examples, a voxel size corresponding to a simulation resolution may be set by a user and/or may be different than a resolution achievable in a 3D manufacturing procedure or by a printer.

In some examples (e.g., multi-jet fusion (MJF)), each voxel in the build volume may undergo a thermal procedure. For example, a thermal procedure may include build time and/or cooling time. Build time may be an amount of time for layer-by-layer printing. An example of a thermal procedure may include 15 hours of build time and 35 hours of additional cooling. In some examples, build time can vary based on the height of the job and/or an amount of cooling time, which may be user specified. The thermal procedure of voxels that include an object may affect the manufacturing quality (e.g., functional quality) of the object. In some examples, voxels may be activated as a corresponding layer is added in the simulation. In some examples, voxels at the bottom of the 3D space may undergo a longer thermal procedure than voxels near the top. In some examples, the whole 3D space may be utilized for manufacturing. In other examples, a part of the 3D space may be utilized for manufacturing (for a short build, for instance), in which case the thermal procedure may take less time than the thermal procedure for a full 3D space.

Thermal sensing may provide a small amount of thermal information (e.g., a small amount of spatial information of the build volume and/or a small amount of temporal information over about 50 hours of build and cooling). For example, a thermal imager (e.g., camera, sensor, etc.) may capture about 10 seconds (or less, for instance) of a thermal voxel's 50-hour procedure when the voxel is exposed as part of a fusing layer, thereby resulting in a lack of temporal coverage. Thermal sensors at the walls and bottom of the build volume may report transient temperatures of a few selected spots, thereby resulting in a lack of spatial coverage.

Some theory-based simulation approaches (e.g., simulations based on thermodynamics laws) may provide additional (e.g., complete) spatial and temporal information for the thermal procedure (e.g., manufacturing). However, some types of simulations (e.g., finite element analysis (FEA)) may be reserved for trained experts because these simulations utilize high-quality meshing. For example, some FEA simulations use meshes to explicitly describe geometry. These types of simulations may be very computationally intensive for 3D printing because each build volume is likely to be different, thus utilizing different meshes. For instance, some FEA simulations have been used in injection molding manufacturing. 3D printing differs from injection molding manufacturing because additional geometrical complexity may not add significant production burden. However, some examples of additive manufacturing (e.g., 3D printing) employ complex shapes (e.g., lattice structures) that push geometrical features close to print resolution. Accordingly, employing some FEA simulation approaches to 3D printing may involve the use of very small elements to describe fine geometrical features with a very large number of elements, thus resulting in a significant computational burden. Some techniques may alter and/or simplify build data to reduce the computational burden. Build data is data that represents an object or objects in a build volume. Some examples of build data may include a 3D Manufacturing Format (3MF) file, object shape data, orientation data, size data, position data, geometry data, etc.

Some examples described herein utilize voxel-based simulation approaches that enable automation. Some examples may utilize build data as input for simulation without expert user intervention. In some examples, simulation resolution may be user controlled independent of geometrical features. Sub-voxel resolution may be utilized to capture geometrical features smaller than the voxel size. For example, a sub-voxel thermal impact may be captured of geometrical features that are smaller than voxel size. Some examples of the approaches may capture other types of physical impacts (e.g., elasticity).

Some benefits of some examples of the approaches described herein may include performing simulation without altering object geometry, performing automated simulation (without expert intervention, for instance), and/or providing flexibility in simulation accuracy to vary with voxel size. For example, some approaches may allow trade-off tuning between simulation accuracy and latency (e.g., processing time to produce results). Some approaches may provide simulation to non-experts to allow analysis of the thermal procedure before printing to infer potential production yield and/or to help ensure that end part quality meets specifications. Some approaches may provide an automated solution for arbitrary build data (e.g., any object size, shape, position, orientation, etc.). Some approaches may provide simulation through sub-voxel resolution. For example, some approaches may provide simulation results with reasonable simulation time even for objects with fine features (e.g., lattices, cages, etc.). Some examples of the techniques described herein may provide object manufacturing simulation (e.g., MJF simulation) that is automated, that allows information at a sub-voxel resolution (e.g., voxel portions) for features smaller than voxel size, and/or that enables simulating digital material (where each voxel may have independent material properties, for instance).

In some examples, object manufacturing simulation may be utilized in determining and/or improving the geometrical accuracy of an object being manufactured (e.g., printed). Object manufacturing simulation may allow determining, before or during printing, the geometrical accuracy of the object.

In some examples, thermal behavior may be mapped as a temperature map. A simulated temperature map is a set of data indicating temperature(s) (or thermal energy) in an area or volume.

While plastics (e.g., polymers) may be utilized as a way to illustrate some of the approaches described herein, the techniques described herein may be utilized in various examples of additive manufacturing. For instance, some examples may be utilized for plastics, polymers, semi-crystalline materials, metals, etc. Some additive manufacturing techniques may be powder-based and driven by powder fusion. Some examples of the approaches described herein may be applied to area-based powder bed fusion-based additive manufacturing, such as Stereolithography (SLA), Multi-Jet Fusion (MJF), Metal Jet Fusion, Selective Laser Melting (SLM), Selective Laser Sintering (SLS), liquid resin-based printing, etc. Some examples of the approaches described herein may be applied to additive manufacturing where agents carried by droplets are utilized for voxel-level thermal modulation. While some resolutions are described herein as examples, the techniques described herein may be applied for different resolutions.

In some examples, “powder” may indicate or correspond to particles insulated with air pockets. A powder's ability to transmit heat is limited, relying on limited touching surfaces among particles. An “object” may indicate or correspond to a location (e.g., area, space, etc.) where particles are sintered, melted, or solidified that is filled primarily with the material itself with no air bubbles or small air bubbles. For example, an object may be formed from sintered or melted powder. An object's ability to transmit heat may be close to that of the bulk material itself.

Throughout the drawings, identical or similar reference numbers may designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

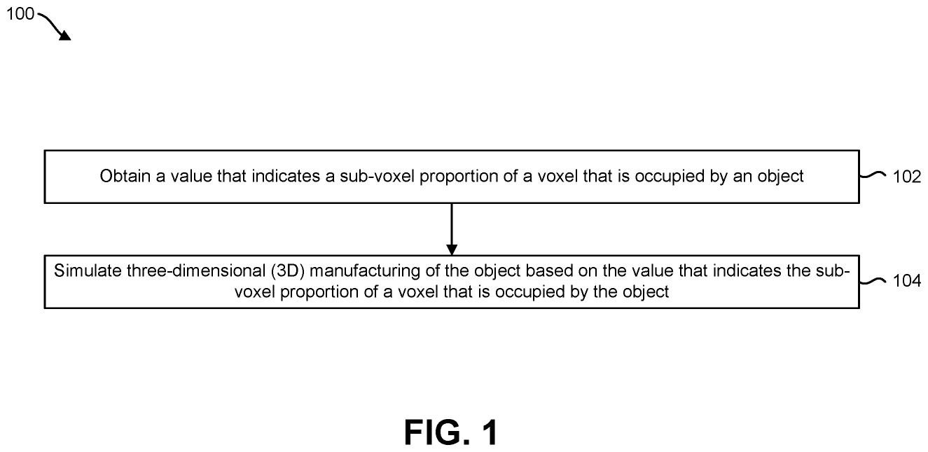

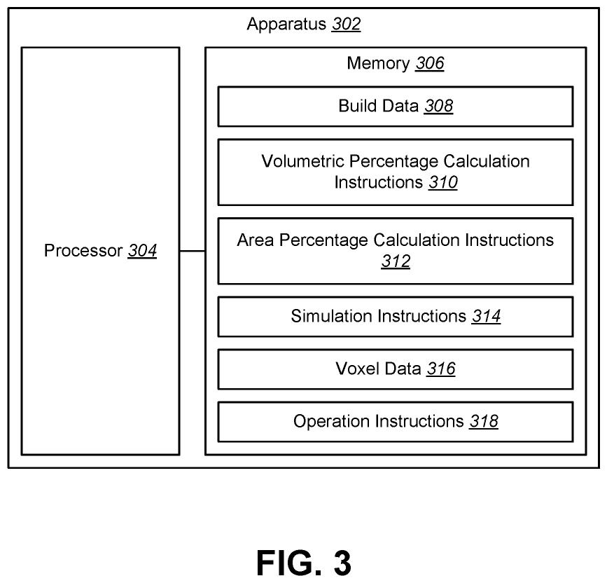

FIG. 1 is a flow diagram illustrating an example of a method 100 for object manufacturing simulation. The method 100 and/or an element or elements of the method 100 may be performed by an apparatus (e.g., electronic device). For example, the method 100 may be performed by the apparatus 302 described in connection with FIG. 3 or a 3D printing device.

The apparatus may obtain 102 a value that indicates a sub-voxel proportion of a voxel that is occupied by an object. The value is a number, code, or expression that indicates a quantity. A sub-voxel proportion of a voxel is an amount of a voxel that is less than all of the voxel. For example, a sub-voxel proportion may be expressed as a fraction, a percentage, a ratio, a decimal number, etc. For instance, an object (e.g., part of an object) may partially occupy a voxel. In some examples, the sub-voxel proportion may indicate an amount of the voxel in which the object is situated. For instance, the value may represent a volumetric percentage of the voxel that is occupied by the object. In some examples, the object may correspond to one type of material (e.g., fused material, sintered material, solid material, metal, etc.), while the remainder of the voxel may correspond to another type or types of material (e.g., powder, wood, etc.). In some examples, the value may indicate the portion of the voxel that is occupied (e.g., occupied by the object) by representing a non-object portion of the voxel. In some examples, the apparatus may store the value as a component or aspect of the voxel.

In some examples, obtaining 102 the value may include determining the value or receiving the value from another device (e.g., a device in communication with the apparatus). For example, the apparatus may determine the value by calculating or computing the value based on build data (e.g., 3MF file and/or data indicating object position, orientation, dimensions, geometry, etc.). In another example, the apparatus may receive the value from another device via a wired communication, wireless communication, and/or network communication.

The apparatus may simulate 104 3D manufacturing of the object based on the value that indicates the sub-voxel proportion of the voxel that is occupied by the object. Simulating 104 3D manufacturing of an object may include determining (e.g., calculating, computing, etc.) a material property or material properties (e.g., thermal behavior, temperature, elasticity, etc.) in a build volume. For example, the apparatus may simulate transient thermal behavior (e.g., temperature over time) based on the value.

Simulating 104 3D manufacturing may produce simulation results. Examples of simulation results may include simulated temperatures, phases, states, elasticity, etc., of material in the build volume. For example, simulation results may include a set or sets of temperatures in the build volume (e.g., grid) at a time or times. In some examples, the apparatus may store the simulation results in memory. In some examples, the apparatus may present the simulation results on a display. For example, the apparatus may render an image of the build volume that indicates the simulation results. For instance, the image of the build volume may be color-coded to indicate temperatures or temperature ranges at locations in the build volume. In some examples, the image may be a 3D image where a portion or portions (e.g., cutaway) may be presented to indicate simulation results in the interior of the build volume. In some examples, the method 100 may be performed for multiple voxels. For example, the method 100 may be repeated for each voxel in a build volume that is partially occupied by an object or objects. In some examples, an apparatus may iterate through all of the voxels in a build volume and may perform the method 100 for a voxel in a case that the voxel is partially occupied by an object.

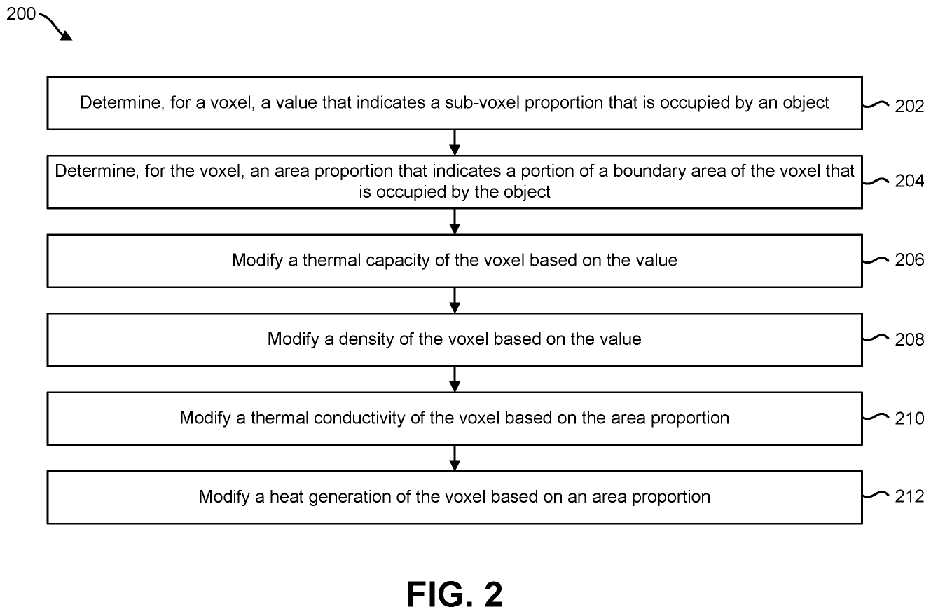

FIG. 2 is a flow diagram illustrating another example of a method 200 for object manufacturing simulation. The method 200 and/or an element or elements of the method 200 may be performed by an apparatus (e.g., electronic device). For example, the method 200 may be performed by the apparatus 302 described in connection with FIG. 3 or a 3D printing device.

The apparatus may determine 202, for a voxel, a value that indicates a sub-voxel proportion that is occupied by an object. For example, the apparatus may determine the value by calculating or computing the value based on build data as described in connection with FIG. 1. In some examples, determining 202 the value for a voxel may include discretizing a portion of a build volume at a first resolution that is greater than a second resolution of the voxel to produce a plurality of constituent voxels. A constituent voxel is a volume that is smaller than a voxel. For example, a voxel may be discretized (e.g., used to generate discrete portions) to produce many constituent voxels that are at a higher resolution than a voxel resolution. Accordingly, a constituent voxel is smaller than a voxel. In some examples, determining 202 the value may include counting a number of constituent voxels within an intersection of the object and the voxel to determine the value. For instance, a number of constituent voxels within a common area between the voxel and the object may indicate the value. For example, the value may be calculated as the number of constituent voxels within the intersection divided by the total number of constituent voxels in the voxel.

In some examples, the apparatus may discretize the build volume using a higher resolution (e.g., print resolution such as 42 micrometers (μm) in x and y dimensions and 80 μm in the z dimension) than voxel resolution. Discretizing the build volume at the higher resolution may produce a set of constituent voxels. For each voxel, the apparatus may count the number of constituent voxels of the object residing in the voxel to produce the value (e.g., volume fraction, volumetric percentage, etc.).

The apparatus may determine 204 for the voxel, an area proportion that indicates a portion of a boundary area of the voxel that is occupied by the object. An area proportion of a voxel is an amount of an area of a voxel. An area of a voxel is a two-dimensional (2D) part of a voxel. For example, a face or side of a voxel may be an area of the voxel. A boundary area of a voxel is an outermost or bordering area of a voxel. In an example with a voxel in the shape of a rectangular prism, the voxel may have six boundary areas corresponding to the faces of the rectangular prism (e.g., top, bottom, left, right, front, and back boundary areas). In other examples, a voxel may have other shapes (e.g., polyhedral shapes) with a different number of boundary areas. In some examples, an area proportion may be expressed as a fraction, a percentage, a ratio, a decimal number, etc. For example, the area proportion may be an area percentage.

In some examples, determining 204 the area proportion may include counting a number of constituent voxels that intercept the object at a boundary of the voxel. For example, the apparatus may count a number of constituent voxels of an object that intercept the boundary area the voxel. The number of constituent voxels that intercept the object divided by a total number of constituent voxels of the boundary area may be the area proportion.

In some examples, the voxel may be represented by three coordinates, three sizes, the value, and six area proportions. For example, three coordinates (e.g., x, y, and z) may represent a location (e.g., center) of the voxel. Three sizes (e.g., dx, dy, and dz) may represent voxel sizes at axis-parallel directions. The value may be a volumetric percentage of the voxel that is occupied by the object (where the remainder of the voxel may be another material type, such as powder). The six area proportions may represent, for each boundary area of the voxel, an area percentage of the boundary area that is occupied by (e.g., in) the object (where the remainder, if any, may be another material type, such as powder). For example, a first area proportion may correspond to a left side of the voxel, a second area proportion may correspond to a right side of the voxel, a third area proportion may correspond to a front side of the voxel, a fourth area proportion may correspond to a back side of the voxel, a fifth area proportion may correspond to a top side of the voxel, and a sixth area proportion may correspond to a bottom side of the voxel. The apparatus may store a voxel in memory as a set of components (e.g., the thirteen foregoing components). In some examples, the build volume may be discretized to produce a set of voxels for the build volume. One, some, or all of the voxels of the build volume may be stored as a set of components (e.g., the foregoing set of components). In some examples, a voxel or voxels may be represented by any subset of the foregoing components. In some examples, size(s) may be omitted (due to being a fixed value or values, for instance). In some examples, the volumetric percentage or the six area proportions may be included but not both.

In some examples, the apparatus may calculate the value in response to determining that an object surface intercepts the voxel. For example, the apparatus may iterate through all of the voxels in a build volume. When a surface triangle of an object intercepts a voxel, the apparatus may compute the value (e.g., volumetric percentage) and/or an area proportion or area proportions (e.g., area percentages) for the voxel. In some examples, a voxel with an intercepting object surface may or may not be marked as a surface voxel. In some examples, other voxels (e.g., interior or exterior voxels) may be stored as the set of components. In other examples, other voxels (e.g., interior or exterior voxels) may be stored with more or fewer and/or different components. For example, an interior or exterior voxel may be stored as three coordinates (e.g., x, y, and z), three sizes (e.g., dx, dy, and dz), and a marker that indicates whether the voxel is an interior or exterior voxel. Accordingly, the build volume may be discretized where all voxels have the same components in some examples or where some voxels have different components in some examples.

In some examples, voxels may be represented and/or stored with redundant area proportion (e.g., boundary area) data. For example, two neighboring voxels along an axis share a common boundary. A left voxel's right area proportion may be the same as a right voxel's left area proportion. While this format uses more data for representation (than a minimum amount, for instance), the format may enable simpler data processing and/or debugging. In some examples, the voxels may be represented without redundant data (e.g., neighboring voxels may share the same area proportion at the neighboring boundary area).

In some examples, to simulate 3D manufacturing, the apparatus may solve a thermal equation. For instance, a thermal equation may be expressed as given in Equation (1).

$$ρ c \frac{\partial T}{\partial t} = k {∇}^{2} T + \dot{q} \qquad ( 1 )$$

In Equation (1), T denotes temperature, t denotes time,

$$\frac{\partial T}{\partial t}$$

is a partial derivative of temperature with respect to time, ρ denotes a density of voxel material, c denotes a thermal capacity of voxel material,

$$ρ c \frac{\partial T}{\partial t}$$

represents a voxel's ability to store heat, k denotes a thermal conductivity, ∇² denotes the Laplacian operator, k∇²T represents heat conduction into and out of a voxel, and \dot{q} denotes heat generation (e.g., heat generation due to a voxel's exposure to an optical energy source through its top surface).

In some examples, the apparatus may account for material changes at a sub-voxel resolution. For instance, the apparatus may perform an operation or operations to modify the material properties of a voxel or voxels. For example, a voxel may include multiple materials (or phases of materials). The material property or properties of a voxel may be modified to account for the multiple materials. In some examples, simulating 3D manufacturing may include modifying the density ρ, the thermal capacity c, the thermal conductivity k, and/or the heat generation \dot{q} based on corresponding factor(s) (e.g., density factor(s), thermal capacity factor(s), thermal conductivity factor(s), and/or heat generation factor(s)).

The apparatus may modify 206 a thermal capacity based on the value. As described above, the value may indicate a sub-voxel proportion that is occupied by an object (e.g., may represent a volumetric percentage of the voxel that is occupied by the object). The thermal capacity signifies a voxel's ability to store thermal energy. In some examples, the apparatus may modify 206 the thermal capacity using a thermal capacity factor or factors based on the value. For example, the thermal capacity of a voxel may be volumetrically proportional due to a mixture of materials of the voxel. In some examples, simulating 3D manufacturing may include modifying a thermal capacity of the voxel based on the value. For instance, the apparatus may utilize a weighted average of the non-object portion and the object portion using the value. The thermal capacity factor or factors may be the weight or weights of the weighted average. The thermal capacity factor(s) may be based on the value. In some examples, the thermal capacity factors may sum to 1 or 100% (e.g., a first thermal capacity factor or weight may be the value and a second thermal capacity factor or weight may be the complement to the value (such as 1−value or 100%−value)). In connection with Equation (1), for instance, the modified thermal capacity c of a voxel may be computed as a weighted average of the object's thermal capacity and the powder's thermal capacity, where the thermal capacity factors are the weights.

The apparatus may modify 208 a density of the voxel based on the value. The density signifies the density of material in a voxel. In some examples, the apparatus may modify 208 the density using a density factor or factors based on the value. In some examples, simulating 3D manufacturing may include modifying a density of the voxel based on the value. For instance, the apparatus may utilize a weighted average of the non-object portion and the object portion using the value. The density factor or factors may be the weight or weights of the weighted average. The density factor(s) may be based on the value. In some examples, the density factors may sum to 1 or 100% (e.g., a first density factor or weight may be the value and a second density factor or weight may be the complement to the value (such as 1−value or 100%−value)). In connection with Equation (1), for instance, the modified density p of a voxel may be computed as a weighted average of the object's density and the powder's density, where the density factors are the weights.

The apparatus may modify 210 a thermal conductivity of the voxel based on an area proportion or area proportions. The thermal conductivity signifies the thermal conductivity of material into and out of a voxel. In some examples, the apparatus may modify 210 the thermal conductivity using a thermal conductivity factor or factors based on the area proportion(s). In some examples, simulating 3D manufacturing may include modifying a thermal conductivity of the voxel based on the area proportion. Each boundary may have a different thermal conductivity. For instance, the apparatus may utilize a weighted average of the non-object portion and the object portion of a boundary area using an area proportion. The thermal conductivity factor or factors may be the weight or weights of the weighted average. The thermal conductivity factor(s) may be based on the area proportion. In some examples, the thermal conductivity factors for a boundary may sum to 1 or 100% (e.g., a first thermal conductivity factor or weight may be the area proportion and a second thermal conductivity factor or weight may be the complement to the area proportion (such as 1−area proportion or 100%−area proportion)). In connection with Equation (1), for instance, the modified thermal conductivity k of a voxel may be computed as a weighted average of the object's thermal conductivity and the powder's thermal conductivity, where the thermal conductivity factors are the weights.

The apparatus may modify 212 a heat generation of the voxel based on an area proportion. The heat generation signifies an amount of heat generation of a voxel. In some examples, the heat generation may be modified for a voxel or voxels on a top surface. In some examples, the apparatus may modify 212 the heat generation using a heat generation factor or factors based on the area proportion. In some examples, simulating 3D manufacturing may include modifying a heat generation of the voxel based on an area proportion. For example, the apparatus simulates a lamp heating effect using heat generation. For instance, the heat generated by a boundary area (e.g., a top boundary area) when exposed as the fusing layer may be proportionally modified based on an area proportion (of the top boundary area). For instance, the apparatus may utilize a weighted average of the non-object portion and the object portion of a boundary area using an area proportion. The heat generation factor or factors may be the weight or weights of the weighted average. The heat generation factor(s) may be based on the area proportion. In some examples, the heat generation factors for a boundary may sum to 1 or 100% (e.g., a first heat generation factor or weight may be the area proportion and a second heat generation factor or weight may be the complement to the area proportion (such as 1−area proportion or 100%−area proportion)). In connection with Equation (1), for instance, the modified heat generation 4 of a voxel may be computed as a weighted average of the object's heat generation and the powder's heat generation, where the heat generation factors are the weights.

Accordingly, the method 200 may use sub-voxel information (e.g., value, area proportion(s)) of a voxel to account for thermal behavior at sub-voxel resolution in some examples. The apparatus may utilize the modified density, thermal capacity, thermal conductivity, and/or heat generation in simulating 3D manufacturing to produce simulation results. In some examples, the apparatus may store the simulation results in memory, present the simulation results on a display, and/or transmit the simulation results to another device.

Some examples of the techniques described herein are described in terms of two materials (e.g., object and powder). In some examples, scalar value and/or area proportions may be utilized. The techniques described herein may also be utilized with more materials (e.g., N materials). For example, instead of using a scalar value and area proportions, vectors (e.g., N−1 vectors) may be utilized, where each component of a vector corresponds to one material. In some examples, additional factors (e.g., weights) may be utilized for more materials.

While some examples of the techniques described herein are described in terms of simulating thermal behavior (via solving Equation (1), for instance), some examples of the techniques described herein may be utilized to simulate other phenomena. For example, some examples of the techniques may be utilized to simulate deformation of objects with complex geometry. For instance, the techniques that generate a thermal capacity factor and a thermal conductivity factor may alternatively be applied to generate a Young's modulus factor and a Poisson ratio factor. The Young's modulus factor and the Poisson ratio factor may be utilized to compute properties of a voxel (e.g., Young's modulus of a voxel) by using a weighted average of Young's moduli of materials that make up the voxel and by using the Young's modulus factor to construct the weighted average formula.

FIG. 3 is a block diagram of an example of an apparatus 302 that may be used in object manufacturing simulation. The apparatus 302 may be a computing device, such as a personal computer, a server computer, a printer, a 3D printer, a smartphone, a tablet computer, etc. The apparatus 302 may include and/or may be coupled to a processor 304, and/or a memory 306. In some examples, the apparatus 302 may be in communication with (e.g., coupled to, have a communication link with) an additive manufacturing device (e.g., a 3D printing device). In some examples, the apparatus 302 may be an example of a 3D printing device. The apparatus 302 may include additional components (not shown) and/or some of the components described herein may be removed and/or modified without departing from the scope of this disclosure.

The processor 304 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 306. The processor 304 may fetch, decode, and/or execute instructions (e.g., simulation instructions 314) stored in the memory 306. Additionally or alternatively, the processor 304 may include an electronic circuit or circuits that include electronic components for performing a functionality or functionalities of the instructions (e.g., simulation instructions 314). In some examples, the processor 304 may be configured to perform one, some, or all of the functions, operations, elements, methods, etc., described in connection with one, some, or all of FIGS. 1-6.

The memory 306 may be any electronic, magnetic, optical, or other physical storage device that contains or stores electronic information (e.g., instructions and/or data). Thus, the memory 306 may be, for example, Random Access Memory (RAM), Electrically Erasable Programmable Read-Only Memory (EEPROM), a storage device, an optical disc, and the like. In some implementations, the memory 306 may be a non-transitory tangible machine-readable storage medium, where the term “non-transitory” does not encompass transitory propagating signals.

In some examples, the apparatus 302 may also include a data store (not shown) on which the processor 304 may store information. The data store may be volatile and/or non-volatile memory, such as Dynamic Random Access Memory (DRAM), EEPROM, magnetoresistive random-access memory (MRAM), phase change RAM (PCRAM), memristor, flash memory, and the like. In some examples, the memory 306 may be included in the data store. Alternatively, the memory 306 may be separate from the data store. In some approaches, the data store may store similar instructions and/or data as that stored by the memory 306. For example, the data store may be non-volatile memory and the memory 306 may be volatile memory.

In some examples, the apparatus 302 may include an input/output interface (not shown) through which the processor 304 may communicate with an external device or devices (not shown), for instance, to receive and store the information pertaining to the object or objects to be manufactured (e.g., printed). The input/output interface may include hardware and/or machine-readable instructions to enable the processor 304 to communicate with the external device or devices. The input/output interface may enable a wired or wireless connection to the external device or devices. The input/output interface may further include a network interface card and/or may also include hardware and/or machine-readable instructions to enable the processor 304 to communicate with various input and/or output devices, such as a keyboard, a mouse, a display, another apparatus, electronic device, computing device, etc., through which a user may input instructions into the apparatus 302. In some examples, the simulation resolution may be controlled (based on input from a user, for instance) independent of geometrical features. For instance, sub-voxel resolution may be utilized to capture geometrical features smaller than the voxel size. In some examples, sub-voxel thermal impact of geometrical features that are smaller than voxel size may be captured. In other examples, the techniques described herein may be utilized to capture other physical impacts.

In some examples, the memory 306 may store build data 308. The build data 308 may be generated by the apparatus 302 and/or received from another device. Some examples of build data 308 include a 3MF file or files, a 3D computer-aided drafting (CAD) image, object shape data, orientation data, size data, position data, geometry data, etc. The build data 308 may indicate the shape and/or location of an object or objects in a build volume.

The memory 306 may store volumetric percentage calculation instructions 310. The processor 304 may execute the volumetric percentage calculation instructions 310 to determine a volumetric percentage indicating a portion of a voxel that is occupied by an object. For example, the processor 304 may calculate an intersecting volume between the object and a voxel. In some examples, the processor 304 may calculate the volumetric percentage by determining a number of constituent voxels in the intersecting volume and dividing a total number of constituent voxels in the voxel to produce a fraction, which may be converted to the volumetric percentage. In some approaches, the processor 304 may calculate a volumetric percentage for each voxel in a build volume, or for a set of voxels along an object surface or object surfaces in the build volume.

The memory 306 may store area percentage calculation instructions 312. The processor 304 may execute the area percentage calculation instructions 312 to determine an area percentage of a boundary of a voxel that is occupied by an object. For example, the processor 304 may calculate an intersecting area between the object and an area (e.g., boundary area, face, side, plane, etc.) of a voxel. In some examples, the processor 304 may calculate the area percentage by determining a number of constituent voxels in the intersecting area and dividing a total number of constituent voxels in an area (e.g., boundary area) of the voxel to produce a fraction, which may be converted to the area percentage. In some approaches, the processor 304 may calculate an area percentage for each side (e.g., boundary, face, etc.) of each voxel in a build volume, or for each side of a set of voxels along an object surface or object surfaces in the build volume.

In some examples, the memory 306 may store voxel data 316. For example, the voxel data 316 may include a volumetric percentage for a voxel or voxels and/or may include an area percentage or area percentages for a voxel or voxels. For instance, a volumetric percentage may be stored as a component of a voxel in the memory 306. An area percentage or area percentages may be stored as a component or components of a voxel in the memory 306. In an example, a voxel (or voxels) stored in the memory 306 may include a coordinate or coordinates indicating the location of the voxel, a size or sizes of the voxel indicating a dimension or dimensions of the voxel, a volumetric percentage, and/or an area percentage or area percentages (e.g., area percentages corresponding to each of six sides of the voxel).

The memory 306 may store simulation instructions 314. The processor 304 may execute the simulation instructions 314 to simulate a temperature distribution of a build volume based on the volumetric percentage. For example, the processor 304 may modify a thermal capacity and/or a density of a voxel based on the volumetric percentage. The processor 304 may calculate the temperature distribution based on the modified thermal capacity and/or the modified density. For instance, the processor 304 may solve Equation (1) using the modified thermal capacity and/or the modified density to produce the temperature distribution.

In some examples, the processor 304 may execute the simulation instructions 314 to simulate a temperature distribution of a build volume based on the area percentage(s). For example, the processor 304 may modify a thermal conductivity and/or a heat generation of a voxel based on the area percentage(s). The processor 304 may calculate the temperature distribution based on the modified thermal conductivity and/or the modified heat generation. For instance, the processor 304 may solve Equation (1) using the modified thermal conductivity and/or the modified heat generation to produce the temperature distribution. In some examples, the processor 304 may modify all or a subset of the thermal capacity, the density, the thermal conductivity, and/or the heat generation for a voxel or voxels to simulate the temperature distribution.

In some examples, the processor 304 may execute the operation instructions 318 to perform an operation based on the simulated temperature distribution. For example, the processor 304 may present the temperature distribution on a display, store the temperature distribution in the memory 306, and/or may send the temperature distribution to another device or devices. In some examples, the processor 304 may manufacture (e.g., print) an object or objects based on the simulated temperature distribution. For instance, the processor 304 may drive model setting (e.g., the size of the stride) based on the simulated temperature distribution. Additionally or alternatively, the processor 304 may perform offline print mode tuning based on the temperature distribution. Additionally or alternatively, the processor 304 may send a message (e.g., alert, alarm, progress report, quality rating, etc.) based on the temperature distribution. For example, the processor 304 may send an alert in a case that the simulated temperature distribution indicates a potential manufacturing issue (e.g., more or less fusion or sintering than a target amount of fusion or sintering).

In some examples, the operation instructions 318 may include 3D printing instructions. For instance, the processor 304 may execute the 3D printing instructions to print a 3D object or objects. In some implementations, the 3D printing instructions may include instructions for controlling a device or devices (e.g., rollers, print heads, and/or thermal projectors, etc.). For example, the 3D printing instructions may use a simulated temperature distribution to control a print head or heads to print such that build volume temperature is regulated. Accordingly, the printing may be based on the simulated temperature distribution.

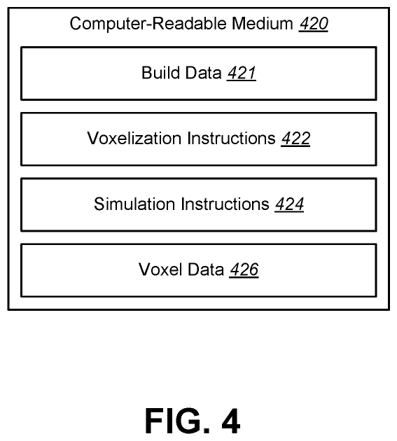

FIG. 4 is a block diagram illustrating an example of a computer-readable medium 420 for object manufacturing simulation. The computer-readable medium 420 may be a non-transitory, tangible computer-readable medium 420. The computer-readable medium 420 may be, for example, RAM, EEPROM, a storage device, an optical disc, and the like. In some examples, the computer-readable medium 420 may be volatile and/or non-volatile memory, such as DRAM, EEPROM, MRAM, PCRAM, memristor, flash memory, and the like. In some implementations, the memory 306 described in connection with FIG. 3 may be an example of the computer-readable medium 420 described in connection with FIG. 4.

The computer-readable medium 420 may include code (e.g., data and/or instructions). For example, the computer-readable medium 420 may include build data 421, voxelization instructions 422, simulation instructions 424, and/or voxel data 426.

In some examples, the computer-readable medium 420 may store build data 421. Some examples of build data 421 include a 3MF file or files, a 3D CAD image, object shape data, orientation data, size data, position data, geometry data, etc. The build data 421 may indicate the shape and/or location of an object or objects in a build volume.

In some examples, the voxelization instructions 422 are code to cause a processor to generate voxel data (e.g., to convert build data 421 to voxels). Each voxel may include sub-voxel geometrical data. For example, the voxelization instructions 422 are code to cause a processor to store, for each voxel of a build volume that intercepts an object surface, a volume fraction variable and a plurality of area fraction variables. The volume fraction variable is a variable that represents a fraction of the volume of a voxel that is occupied by an object. Each area fraction variable is a variable that represents a fraction of an area (e.g., side, face, plane, etc.) of a voxel that is occupied by an object. The volume fraction variable may be an example of the value that indicates a sub-voxel proportion described herein. An area fraction variable may be an example of the area proportion described herein. The volume fraction variable(s) and/or the area fraction variable(s) may be stored as voxel data 426 in the computer-readable 420 or in another electronic memory device. In some examples, the voxelization instructions 422 may be executed to convert build data 421 (e.g., a batch of objects, a mesh, etc.) into a set of voxels for a build volume, where a voxel or voxels of the build volume include the volume fraction variable and/or the area fraction variable(s).

In some examples, the simulation instructions 424 are code to cause the processor to simulate thermal behavior of the build volume based on the volume fraction and the plurality of area fraction variables. For example, the simulation instructions 424 may be executed to calculate a physical thermal model (e.g., Equation (1)) based on the volume fraction and the plurality of area fraction variables. For instance, the physical thermal model or material properties thereof may be adjusted or modified based on the volume fraction and the plurality of area fraction variables. In some examples, simulating the thermal behavior may include performing a transient thermal simulation (that includes layer build-up and cooling, for instance) based on the voxel data structure. For example, the simulation may use sub-voxel geometrical data to compute material properties for each voxel (e.g., thermal voxel). The simulation may indicate and/or produce a transient thermal temperature for each voxel. In some examples of the techniques described herein, post-processing may be performed (e.g., by the apparatus 302 described in FIG. 3). The post-processing may utilize the simulation results to indicate aspects of manufacturing and object functionality.

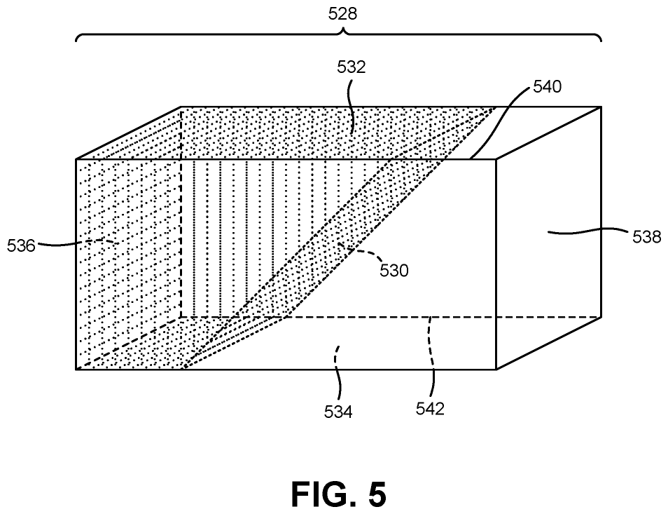

FIG. 5 is a diagram illustrating an example of a voxel 528 that is partially occupied by an object 530. The voxel 528 may be an example of the voxel or voxels described in connection with FIGS. 1-4. In this example, the voxel 528 has a rectangular prismatic shape with six boundaries: a top boundary 532, a bottom boundary 534, a left boundary 536, a right boundary 538, a front boundary 540, and a back boundary 542. The object 530 may extend beyond the voxel 528. The portion of the voxel 528 that is occupied by the object 530 is marked with dotted lines.

As described herein, an apparatus (e.g., the apparatus 302 described in connection with FIG. 3) may determine a sub-voxel proportion of the voxel 528 that is occupied by the object 530. In the example illustrated in FIG. 5, the sub-voxel proportion may be half of the voxel, where the sub-voxel proportion may be indicated by a value. Examples of the value may include a volumetric percentage, a volume fraction, a decimal number, a floating point number, a ratio, and/or another expression. For instance, the value may be expressed as 50%, ½, 0.5, 1:1, or another expression for this example.

As described herein, an apparatus (e.g., the apparatus 302 described in connection with FIG. 3) may determine area proportions for boundary areas of the voxel 528 that are occupied by the object 530. In the example illustrated in FIG. 5, the area proportion for the top boundary 532 is 75%, the area proportion for the bottom boundary 534 is 25%, the area proportion for the left boundary 536 is 100%, the area proportion for the right boundary 538 is 0%, the area proportion for the front boundary 540 is 50%, and the area proportion for the back boundary 542 is 50%, where the area proportions are expressed as area percentages. The area proportions may be expressed as area percentages, fractions, decimal numbers, floating point numbers, ratios, and/or another expression. For instance, the area proportion for the top boundary may be expressed as 75%, ¾, 0.75, 3:1, or another expression for this example. As described herein, a voxel may be represented with (e.g., stored with) the value and area proportions.

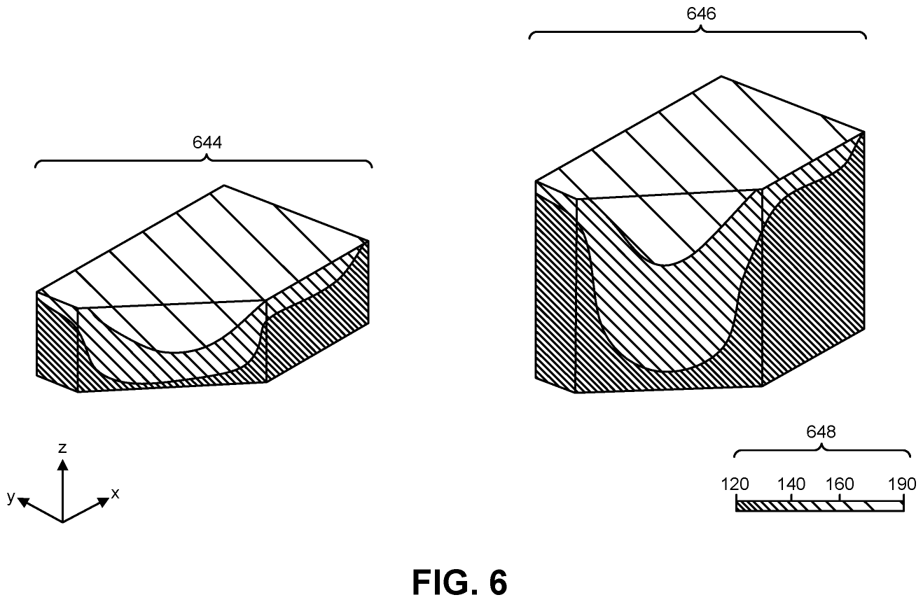

FIG. 6 is a simplified perspective view of an example of visualizations 644, 646 of simulation results in accordance with some examples of the techniques described herein. The visualizations 644, 646 are simplified temperature maps corresponding to a build volume at different times. For example, the first visualization 644 illustrates simulation results of 3D manufacturing at a first time, and the second visualization 646 illustrates simulation results of the 3D manufacturing at a second later time. Both of the visualizations 644, 646 include cutaways to illustrate internal temperatures. In this example, the temperatures are illustrated on a simplified scale in degrees Fahrenheit 648. Other examples may be illustrated on a color gradient scale to show finer temperature variation than the example in FIG. 6.

In some examples, visualizations of simulation results may be presented on a display and/or simulation results may be sent to another device (e.g., computing device, monitor, etc.) to present visualizations of simulation results. In some examples, a semi-transparent overlay of an object or objects (from build data, for instance) may be presented with or on a visualization to show a correspondence between a manufactured object and build volume temperature. In some examples of the techniques described herein, with sub-voxel features, a relatively large 2 mm voxel size may capture build geometry and fine features.

In the example illustrated in FIG. 6, the simulation reflects manufacturing where objects are built up layer by layer. In this example, the simulation (of an approximately 50-hour manufacturing procedure) was completed in approximately an hour.

Some examples of the techniques described herein may enable graceful degradation in simulation accuracy as a function of simulated voxel size. For example, a simulation similar to the one shown in FIG. 6 may be performed with a larger 4 mm voxel, where the simulation is completed in about 15. While the simulation results with a larger voxel size are less accurate, the simulation results may convey thermodynamic information in a quantitative fashion.

In some examples of the techniques described herein, material properties may become per-voxel field quantities, which may enable discrete modeling where each voxel of material can vary. For example, each voxel may have a different thermal capacity because each voxel may hold different portions of material (e.g., object versus powder). Because each voxel may have a different thermal capacity, each voxel's ability to hold heat may be different.

While various examples of systems and methods are described herein, the systems and methods are not limited to the examples. Variations of the examples described herein may be implemented within the scope of the disclosure. For example, operations, functions, aspects, or elements of the examples described herein may be omitted or combined.

1. A method, comprising:
simulating three-dimensional (3D) manufacturing of an object based on a value that indicates a sub-voxel proportion of a voxel that is occupied by the object.

2. The method of claim 1, further comprising determining the value for the voxel.

3. The method of claim 1, wherein the value represents a volumetric percentage of the voxel that is occupied by the object.

4. The method of claim 1, further comprising determining an area proportion that indicates a portion of a boundary area of the voxel that is occupied by the object.

5. The method of claim 4, wherein the area proportion is an area percentage.

6. The method of claim 1, wherein the voxel is represented by three coordinates, three sizes, the value, and six area proportions.

7. The method of claim 1, further comprising calculating the value in response to determining that an object surface intercepts the voxel.

8. The method of claim 1, further comprising:
discretizing a portion of a build volume at a first resolution that is greater than a second resolution of the voxel to produce a plurality of constituent voxels;
counting a first number of constituent voxels within an intersection of the object and the voxel to determine the value; and
counting a second number of constituent voxels that intercept the object at a boundary of the voxel to determine an area proportion.

9. The method of claim 1, wherein simulating the 3D manufacturing comprises modifying a thermal capacity of the voxel based on the value.

10. The method of claim 1, wherein simulating the 3D manufacturing comprises modifying a density of the voxel based on the value.

11. The method of claim 1, wherein simulating the 3D manufacturing comprises modifying a thermal conductivity of the voxel based on an area proportion.

12. The method of claim 1, wherein simulating the 3D manufacturing comprises modifying a heat generation of the voxel based on an area proportion.

13. An apparatus, comprising:
a memory;
a processor in electronic communication with the memory, wherein the processor is to:
determine a volumetric percentage indicating a portion of a voxel that is occupied by an object; and
simulate a temperature distribution of a build volume based on the volumetric percentage.

14. The apparatus of claim 13, wherein the processor is to:
determine an area percentage of a boundary of the voxel that is occupied by the object.

15. A non-transitory tangible computer-readable medium storing executable code, comprising:
code to cause a processor to store, for each voxel of a build volume that intercepts an object surface, a volume fraction variable and a plurality of area fraction variables; and
code to cause the processor to simulate thermal behavior of the build volume based on the volume fraction variable and the plurality of area fraction variables.
